(19) United States
(12) Patent Application Publication
(10) Pub. No.: US 2007/0137988 A1
(43) Pub. Date: Jun. 21, 2007

(54) Computer control of audio/video switching

(75) Inventors: Tse-Ching James Yu, Woodinville, WA (US); William J. Westerinen, Issaquah, WA (US); Ruston Panabaker, Bellevue, WA (US); Yingchun Simon Zhang, Redmond, WA (US); Richard Herman Hagemeyer III, Bothell, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/292,793

(22) Filed: Dec. 2, 2005

(51) Int. Cl. H01H 9/00; G06F 15/16

(52) U.S. Cl. 200/4; 709/201

(57) ABSTRACT

Described are computer-controlled switching mechanisms that couple various audio/visual devices' outputs to the inputs of other audio/visual devices. The user (or some process) selects an audio/visual operating mode via a computer system, and the computer system controls the switching mechanism to couple audio/visual devices in a way that matches the mode. The computer may also control settings and operations of some or all of the devices.

### BACKGROUND

Computing and audio/visual entertainment are beginning to merge, as consumers are beginning to use a personal computer to perform tasks such as personal video recording (PVR), DVD playback, listening to music, and/or viewing of digital photographs on television sets. However, a significant challenge exists in that current personal computer architectures are not designed to easily or optimally connect with the other consumer electronics (CE) devices, such as audio/visual receivers, televisions, and set-top boxes.

In general, and by way of example, consider a typical living room setup with a television set, audio/visual receiver, cable or satellite set-top box, game console, and speakers. Most contemporary digital televisions only have one DVI (digital visual interface) or HDMI (high definition multimedia interface) input. Mainstream audio/visual receivers do not support DVI or HDMI inputs/outputs. Digital cable/satellite set-top boxes are (or will be) supporting DVI or HDMI outputs. However the personal computing trend is heading towards having only DVI connectors for the video output, as LCD monitors become the norm for computer displays.

Given such an example scenario, the user is presented with significant challenges in the setup of a typical living room environment if desiring to use a personal computer with other consumer electronics devices. For example, if the user wants to use the personal computer and television for (what is now considered) conventional computing tasks, or even DVD playback, the user needs to connect the personal computer to the television set through the DVI connection, and then connect the computer's audio output to the receiver (or television set's audio inputs). To do this when one or more other consumer electronics devices are already connected, before the personal computer can be used, often the user may first needs to disconnect one or more of the other devices, connect the personal computer to the appropriate television and/or receiver inputs, switch the television to the appropriate video input, and also switch the receiver to the appropriate audio input. Once the user is done, most or all of these connections and/or settings need to be restored in order to again use another consumer electronics device.

In addition, video and audio sources are normally switched together on audio/visual receivers. However a personal computer will often be connected directly to the television, with a separate audio cable connected to the audio/visual receiver. Such a scenario also assumes that the user does not want to use another DVI/HDMI connection into the television, such as for a digital cable/satellite set-top box viewing, and/or game console operation. To use such a secondary DVI connection, the user needs to buy an external DVI switch box (which is relatively expensive) or needs to manually change the video wiring (e.g., at the source) each time a different DVI connection is desired. The complexity of setup and usability increases greatly (e.g., exponentially) with each additional piece of consumer electronics equipment that is added into a system.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards controlling a switching mechanism via a computer to match an audio/visual mode selected via the computer system. The switching mechanism is controlled to couple one or more audio and/or visual outputs of a first device set to one or more audio and/or visual inputs of a second device set. Each device set comprises at least one other audio and/or visual device, and the computer may also control settings on some or all of the devices. A configured mode may be selected from among multiple modes, whereby the computer is capable of switching different output sources to different inputs to match the modes.

Other advantages will become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose computing environment into which various aspects of the present invention may be incorporated.

FIG. 2 is a block diagram representing an example configuration of audio/visual devices having connections coupled via a personal computer system-controlled internal (or closely-associated) switching mechanism.

FIG. 3 is a block diagram representing an example configuration of audio/visual devices having connections coupled via an external switch controlled by a personal computer system.

FIG. 4 is a representation of an example computer-controlled audio/visual switch.

FIG. 5 is a representation of an example computer-controlled audio (sound) subsystem and video capture subsystem for processing and switching video and audio data.

FIG. 6 is a representation of an example computer-controlled audio/visual switch in which input may be switched through for output and/or captured/processed before output.

### DETAILED DESCRIPTION

Exemplary Operating Environment

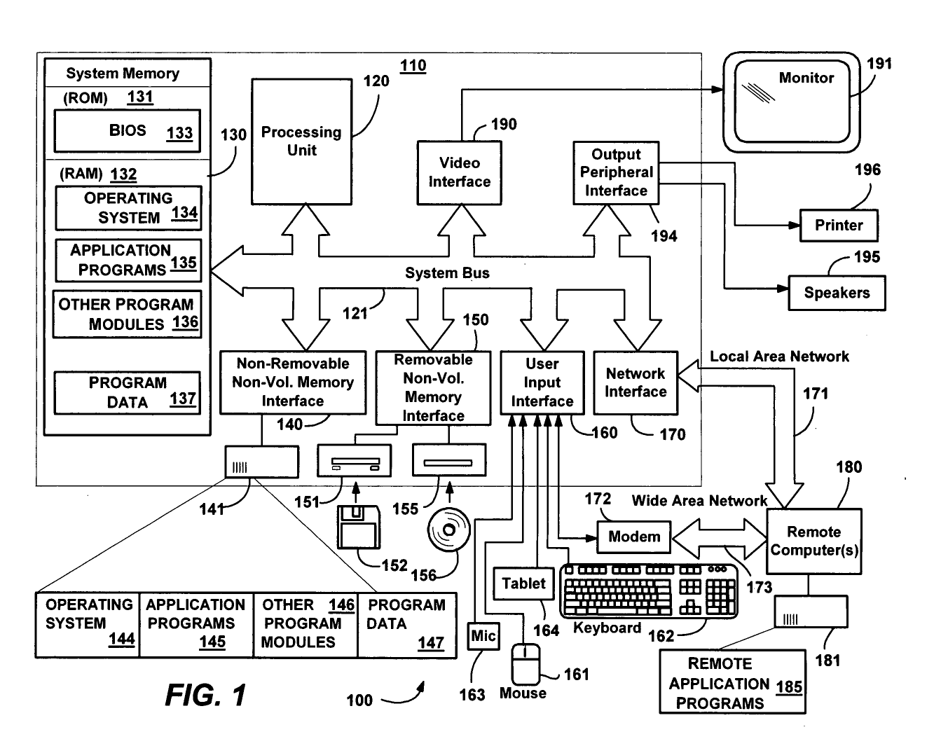

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, described above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Computer Control of Audio/Video Switching

Various aspects of the technology described herein are directed towards controlling the switching of audio and/or visual (audio/visual or A/V) devices (i.e., their inputs and/or outputs) via one or more software programs running on a personal computer. The personal computer is typically a desktop or laptop running a general-purpose operating system, such as Microsoft Windows® Media Center Edition, but also includes devices such as hand-held/pocket-sized PCs, cellular phones, and so forth. In general, as described below, the personal computer may physically include (e.g. within its housing) some or all of the switching mechanisms necessary to couple outputs to inputs and inputs to outputs. Alternatively, some or all of the switching mechanisms may be in a separate housing (e.g., a standalone box or components within another device such as a television or receiver) controlled by the computer system. Thus, as will be understood, the present invention is not limited to the examples used herein, but may also apply to other configurations, implementations, A/V devices and so forth.

Moreover, it should be noted that as used herein, the term “switch” and its variants (e.g., “switching”) are not limited to exclusively switching an input to a single output, but rather can couple one input to multiple outputs; thus switching can be considered analogous to signal routing and/or signal distribution. Further, via signal processing, conversion/encoding and so forth, the outputs need not match the inputs, and thus “switching” includes any coupling of an input to an output, whether direct or indirect (e.g., after some signal processing). For example, analog audio input may be converted to digital output, switched directly or indirectly (e.g., possibly after processing and/or delaying) to analog output, or coupled to both analog and digital output. As another example, component video input may be switched to component video output, and/or to composite video out, and/or to DVI/HDMI out, and so forth. As such, any of the examples mentioned herein are non-limiting, and the present invention may be used various ways that provide benefits and advantages in computing and audio/visual activities in general.

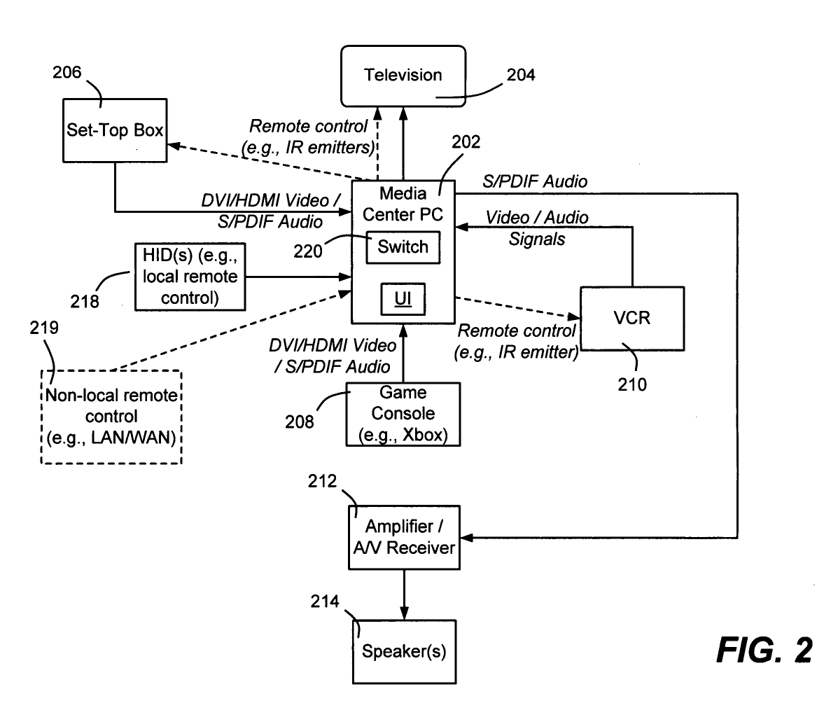

Turning to FIG. 2 of the drawings, there is represented an example embodiment in which various types of audio/visual devices are coupled to one another via a personal computer (PC) 202, (such as the computing device 110 of FIG. 1 configured with an operating system such that the computer system serves as a media center PC). Non-limiting examples of audio/visual devices shown in FIG. 2 include a television (or monitor) 204, a set-top (e.g., cable or satellite) box 206, a game console (e.g., Xbox 360™) 208, a VCR 210, and an amplifier (and/or A/V receiver) 212 coupled to speakers 214; (an A/V receiver may have its own switching as well, which can be leveraged to some extent for switching in conjunction with the switch 220). Note that the PC 202 itself may serve as a source of audio/visual output; for example, the PC 202 may output its graphics (and possibly audio) to the television 204, and may serve as a DVD player or digital picture source.

Also shown coupled to the media center PC 202 is one or more human interface devices (HIDs) 218. Examples of such input devices include as a wired/wireless keyboard and/or pointing device, a touch and/or pen sensitive digitizer, a microphone, a camera, a remote control and corresponding receiver, and other wired or wireless input/output mechanisms. One typical HID 218 comprises a remote control sensed by the personal computer, which has the benefit of removing the need for the user to use separate remote controls for multiple device in favor of only one. Alternatively, one or more other remote controls may be used, sensed by a corresponding device or devices, with information relayed back to the personal computer system. Also, although not specifically represented, the personal computer may be controlled by non-human mechanisms, e.g., to switch connections upon events such as timers and/or date/time, existing state (e.g., do not switch video to another source when a game is actively being played), and so forth. Still further, a non-local control device with commands that are delivered over a network, such as a local network or the internet (e.g., via TCP/IP) may be employed to remotely control the computer-controlled switching operations.

The media center PC 202 represented in FIG. 2 includes a switch mechanism 220 for coupling PC-controlled inputs (receiving the outputs of A/V source devices) to PC-outputs, which are in turn coupled to A/V device inputs. To this end, the media center PC 202 is shown as including (or being closely associated with) the switch 220. Examples of built in or closely-associated switching mechanisms include a discrete plug-in board or boards (e.g., PCI-based), a motherboard-integrated solution, a wired (or relatively short-range wireless-coupled) discrete device such as a USB-type device, and/or combinations of the above examples.

Also represented in FIG. 2 is a user interface (UI) component, such as a rich graphical user interface by which a user can set up various sets of connections based on a desired action. For example, via the user interface (UI), a user can designate a “game” mode that when entered, automatically couples the video output (of any type or types the game is capable of outputting) of the game console 208 to the input (or inputs) of the television 204. The television may receive different types of input, which need not necessarily match the game console's type of output. Likewise, the game console's audio outputs may be automatically coupled to the inputs of the receiver 212, or to audio inputs of the television 204, or both, depending on what the user desires in this particular mode. Note that multiple modes for the same general type of operation are feasible, e.g., a user may have one game mode with rich surround sound-type audio output, and another game mode for “quiet” play in which the audio output is through headphones. A user may use the user interface to override the settings of existing modes, without necessarily persisting the changed settings unless desired.

Moreover, the media center PC 202 may include one or more device control mechanisms such as wireless (e.g., infrared) emitters, serial connections, USB connections and so forth. As a result, the media center PC 202 can control the operation of the audio/visual devices. For example, in the above game mode scenario, when the game mode is selected, the media center PC 202 may emit control signals to automatically turn on the television 204 and change the television's video mode to the required input (or inputs, e.g., if split screen, picture-in-picture and/or other effects are desired) for game play.

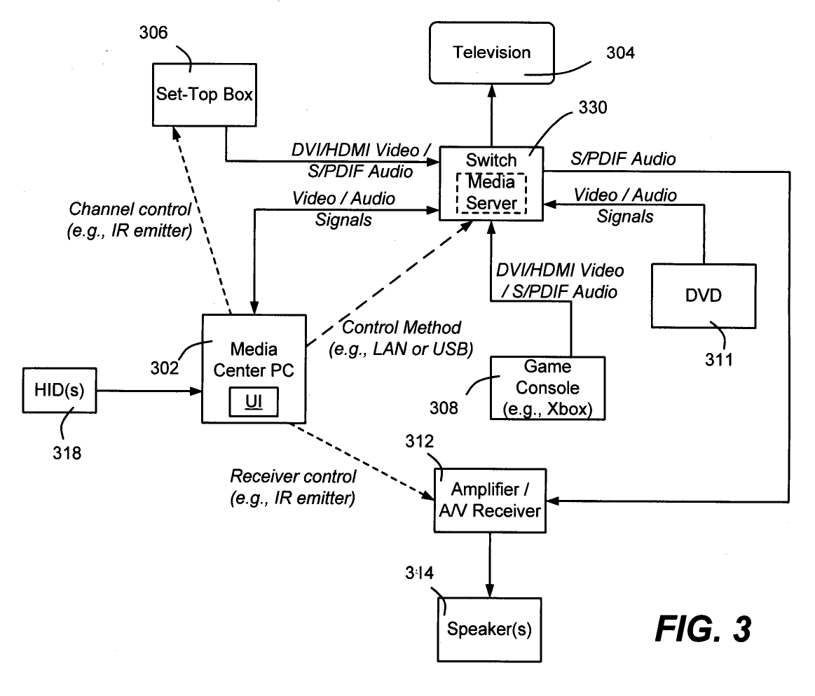

FIG. 3 is an alternative embodiment that is somewhat similar to the embodiment of FIG. 2, except that the switching mechanism (switch) 330 is external to (or not necessarily closely associated with) the PC 302. Note that the components and the like shown in FIG. 3 are labeled similarly to those of FIG. 2, except that each is labeled as “3xx” rather than “2xx” to indicate that they need not be the same device/component, but rather one that performs similarly; also note that a DVD player 311 is shown in FIG. 3 (rather than a VCR 210 as in FIG. 2) to emphasize the flexibility of the technology described herein.

Thus, in the example implementation of FIG. 3, the switch 330 is controlled by the PC 302, but is positioned relatively remotely thereto. To this end, the switch 330 may be controlled by USB or by a signal over another type of connection, or via LAN, WLAN or WAN (including the internet); as such, certain implementations of the remote switch 330 may be generally considered a media server, somewhat analogous to a print server. Moreover, although not explicitly represented as such in FIG. 3, the external switch 330 may be built-into the television 304 or amplifier and/or receiver 312, or contain parts thereof in both, e.g., audio switching in the receiver 312, video in the television 304. Moreover, a hybrid model in which some of the switching is internal to (or closely associated with) the PC and other of the switching is external/remote to the PC is feasible. For example, an internal PCI card may handle some of the switching duties, while an external switch may handle other switching duties.

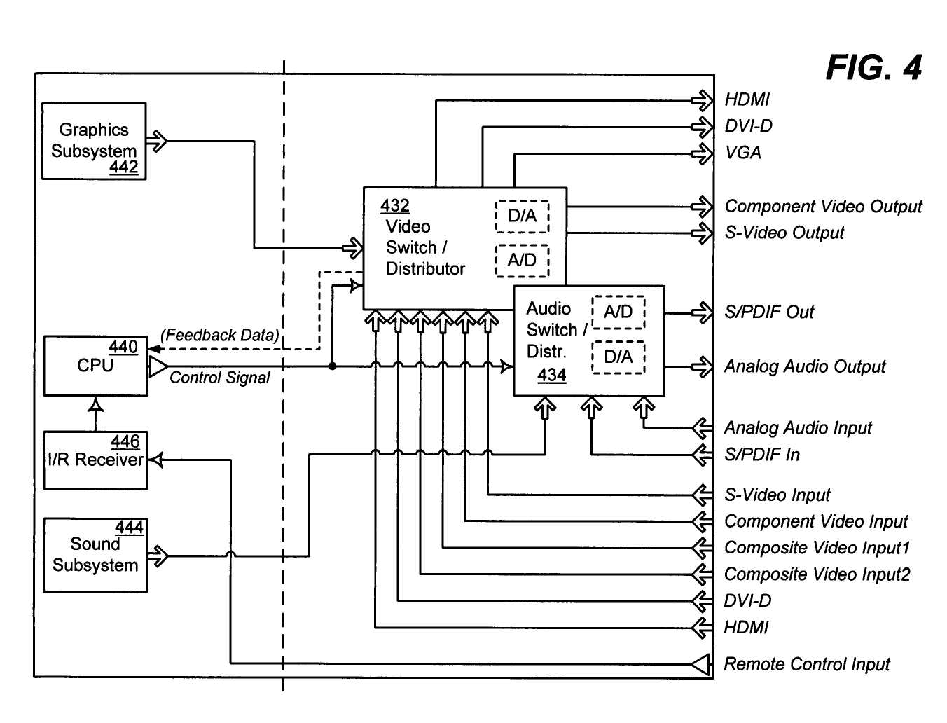

FIG. 4 exemplifies a switching mechanism, including a video switch (and/or distributor) 432 and audio switch (and/or distributor) 434. The switching mechanisms 432 and 434 may include (or be coupled to) one or more converters such as D/A or A/D converters, encoders, decoders and other signal processing components.

The switching mechanisms 432 and 434 are coupled to a digital control signal of a computer system, such as the media center PC, as generally represented via the CPU 440; note that memory and (possibly) some persistent storage as well as other typical computer components, including any operating system and running programs, are inherently represented by the CPU 440. Note that the connection that handles the control signal may be bidirectional, or a separate return connection may be provided, so that control signals are sent by the CPU 440, while status and information (feedback) may be returned. For example, detection logic and/or circuitry may be provided to notify the CPU as to the state of what is physically coupled, whether valid signals are being received, and so forth. The dashed feedback line from the switch 432 to the CPU 440 represents such optional bidirectional communication over one or more connections; note that the feedback can come from a source in some other way, i.e., not necessarily through the switch. Note that one such solution for transferring control data may use an extension of DDC/CI (Display Data Channel/Command Interface), a command and control mechanism that already exists and can be used to communicate data over an existing (e.g., video) connection. Other protocols and solutions for providing two-way communication where appropriate are equivalent.

As also represented in FIG. 4, examples of types of video that can be switched from input to output include, but are not limited to, S-video, component video, composite video, DVI-D, DVI-A, DVI-I (Digital Video Interface, -Digital,-Analog or -Integrated, respectively), and HDMI (High Definition Multimedia Interface). Other types of video not specifically depicted in the drawings are inherently represented, and include SCART (Syndicate for Constructors of Apparatus for Radio and Television), for example. Further, note that any color-scheme (e.g., RGB, BGR, CMY or other component) may be in use where appropriate. Not all inputs shown are required in a given system (e.g., DVI and HDMI may be converted to one another), and more inputs may be present, including for future interface technology. Analog and/or digital audio, e.g., S/PDIF (Sony/Philips Digital Interconnect Format) are also represented. Note that HDMI can include both audio and video, and these can be switched as one, or separated and switched independently.

For use as a general purpose device, in addition to the CPU 440 and its inherent components, the controlling computer system includes a graphics subsystem 442 and a sound subsystem 444, such as built into an add-on (e.g., PCI-based) cards and/or on-board integrated mechanisms. Note that the dashed vertical line in FIG. 4 represents one possible physical boundary, e.g., the PC portion may be on the left of the dashed line, with an external switching mechanism (e.g., as in FIG. 3) on the right of the dashed line. However, (e.g., as in FIG. 2), one or both of the switches 432 and 434 or some part thereof may be incorporated into the physical housing of the PC. Further, some input device is also present in conjunction with the PC, such as represented in FIG. 4 by the infrared (IR) receiver 446. Although not specifically, shown, a wired/wireless keyboard and/or pointing device may be present, and other wired or wireless input/output mechanisms and connections may be present instead of or in addition to the IR receiver 446, such as one or more wire-coupled devices, e.g., based on LAN/Ethernet, USB, firewire, and possibly one or more other devices, and/or wireless-coupled devices, e.g., based on FM, WLAN, wireless USB, BlueTooth®, and so forth.

With respect to the user interface for initially configuring and thereafter selecting a mode, the user may have to initially turn on the television and A/V receiver in conjunction with the PC, or the PC may be capable of turning the A/V devices on, as described above. In a setup mode, the television screen will display the user interface (e.g., its home page) whereby the user may select what mode/function to perform and specify some or all of the connections to switch. Note that some default preset modes may be present, e.g., for game or DVD playback, or the UI can guide the user through options.

Once configured or default preconfigured, the user selects a mode, such as DVD playback, in conjunction with loading the chosen DVD (which may also be chosen and automatically loaded via the PC if a jukebox-like DVD loader is present). The control program running on the PC (CPU 440) sends a command through the control channel/method to signal the video switch to switch to the input that is coupled to the DVD player's output, and connect from the switch output to the appropriate television input. Also, the PC controls the audio switch to accept S/PDIF input from the DVD player and output S/PDIF to the A/V receiver's input. The audio going out through S/PDIF is typically set at the optimal sound quality available, possibly with effects as desired by the user.

After the user is done watching the DVD, the user may select a Music mode/function and select a song, e.g., from a digital library. The audio is automatically switched to stereo output, for example, and depending on the user's settings, the television's display may be blanked (or turned off) or show a visualization.

As can be readily appreciated, by having the personal computer control audio/video switching, many of the problems and setup complexities users have in configuring setups, as well as any need for manual switching, are substantially eliminated. For example, users not need to memorize or write down the many possible mappings of audio and video outputs to inputs. As a result, even relatively unsophisticated users will be able to integrate PCs with their audio/visual devices, and be provided with an enhanced digital entertainment experience.

By way of another example, one user setup may have the personal computer's video output connected to a television via DVI/HDMI and audio output connected to a receiver through S/PDIF, a digital cable/satellite set-top box connected to the personal computer through a DVI/HDMI for Video and S/PDIF for audio, a game console connected to the PC through DVI/HDMI for Video and S/PDIF for audio. From this scenario, the TV is always using the same video input, the receiver is always using the same audio input, yet no additional connection between a set-top box or game console is needed.

Once connected in this way, from the user's perspective all that need be done is to turn on each of the components (or have the PC turn them on), and let the switching connections be controlled by the PC. Through a user interface, (which can provide a rich UI experience that is far more sophisticated than on-screen menus and the like those provided by conventional AV devices), the user can select an action, e.g., to playback from a DVD. To this end, the user selects a DVD mode, e.g., using a PC remote control, and the PC switches the connections to match the user's configuration, which will typically optimize the user's DVD experience, including, for example, setting the sound system to the user's preferences. If the user decides to watch or record television, the user selects a TV (and/or recording) mode, and the PC switches the video and audio for TV/recording functionality.

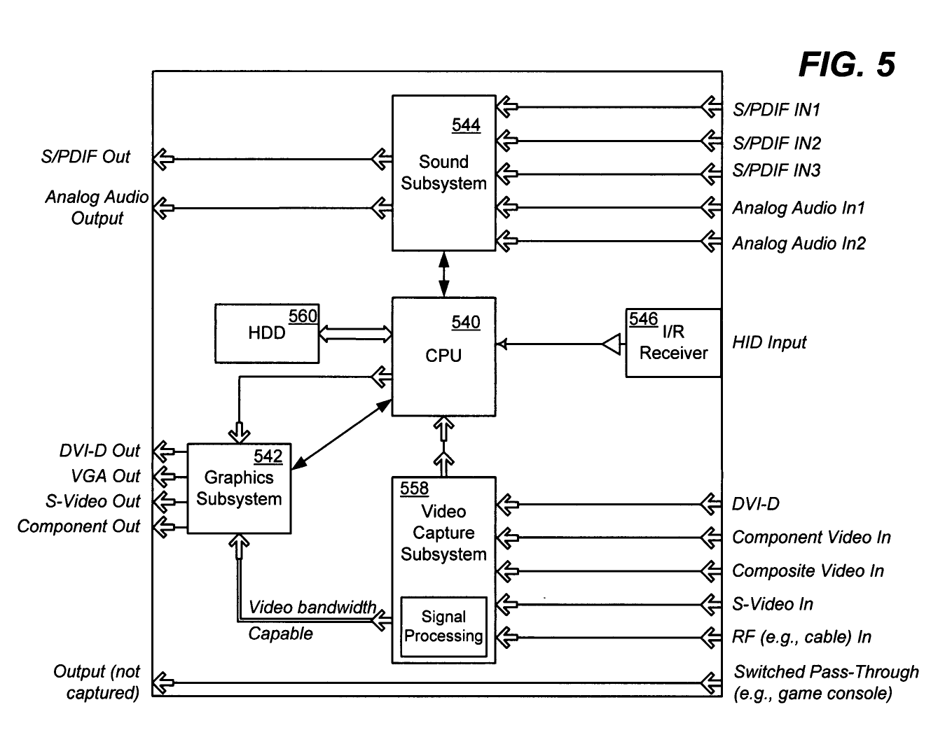

FIG. 5 is a representation of an alternative implementation, which uses a video capture subsystem 558 (card or integrated equivalent) and a sound subsystem 544 (card or integrated equivalent) to handle the switching structure and functionality. The video and sound subsystems, 558 and 544 respectively, may be on a single unit, such as a single PCI card, but in any event are synchronized. One benefit to this approach is that video and audio from the various sources is captured and processed through the operating system (represented by the CPU 540), where it can be manipulated as necessary and/or desired, e.g., processed, encoded, decoded, decrypted, and/or recorded. To this end, the PC (represented by the CPU 540) performs any real time encoding and decoding of the content as necessary before it is displayed. A powerful processor (or co-processor) may be used to avoid or reduce degradation of system performance. Also note that FIG. 5 shows that the video capture subsystem 558 may have its own signal processing circuitry and/or logic (e.g., D/A or A/D conversion), as represented by the “signal processing” block within the video capture subsystem 558.

Further, with such cards or integrated solutions, dedicated audio/video switching circuitry is unnecessary, whereby the cost will likely be lower for most users. A still further benefit from this capturing implementation is that it is possible to perform visual effects such as picture-in-picture (PIP), scaling, split screen, windowing, tiling, thumbnail selection, and so forth using the video from different sources. To this end, as represented in FIG. 5, the CPU 540 receives the video input and outputs it through graphics subsystem 542, e.g., via the GPU frame buffers. A hard disk drive (HDD) 560 or the like may be used for recording video content and playing it back. In fact, audio can be mixed, or different audio sources routed to different outputs, e.g., two viewers viewing two different programs in a split screen mode can each receive their own audio feeds, such as over different headphones, or one via headphones and another via speakers.

Also note that not all of the inputs need be captured, but rather can simply pass through. For example, a user may have no wish to capture game playing output, as among other reasons, this may introduce some delay, whereby additional synchronization between the user's button and what is currently being rendered is required so as to take the appropriate actions. Thus, the system may provide one or more sets of A/V inputs that are simply switched to pass through. This is generally represented in FIG. 5 by the switched pass-through connection.

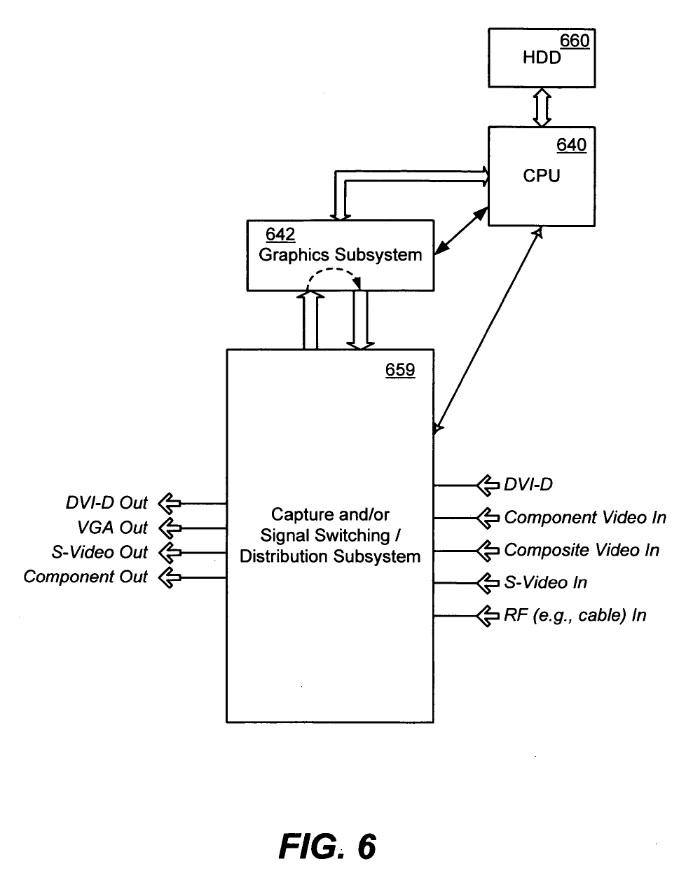

Yet another example implementation comprises what is to an extent essentially a hybrid of the above-described example switching solutions. FIG. 6 provides an example representation of such an implementation, in which the capture subsystem 659 includes (or is otherwise closely coupled to) the switching mechanism. Note that audio is not shown for purposes of simplicity, but is handled similarly.

In this example implementation, some or all of the input may be captured, while other input may be passed through, depending on the user's current preference. For example, a user simply watching a live program or DVD without any desire to record the content may simply elect a mode that switches the signals through. A user desiring other behavior such as showing a video program in one window while other windows display other content (such as a spreadsheet), can capture the video to route it though the graphics subsystem 642. Again the CPU 640 represents the components that control the switching and/or routing of the signals, which can also be recorded. With this implementation, a user can view uncompressed raw video, as well as compressed/encoded video, as needed.

It should be noted that digital rights management/copy protection may be implemented as needed in the various implementations, and persisted throughout the system. For example, when not using a straight pass-through switch (in which event the initial source and destination will be implementing any protection scheme), information about copy protection may be provided to the PC, where intelligent decisions can be made about handling the content. For example, the operating system knows about the copy protection (e.g., HDCP, or high-bandwidth digital-content protection) in use, and can alter its behavior as to what is allowed and what is not, e.g., to not allow copying or the driving of certain outputs. Some or all of the protection mechanisms may also be encoded in the switches. In general, regardless of where implemented, the computer-based switching of A/V content may be controlled based on outputs and inputs in order to control denial of service based on content protection/digital rights management; e.g., transmitting video content from a DVD over HDMI may not be allowed for protected content, but the same content may be switched over component or composite video.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. At least one computer-readable medium having computer-executable instructions, which when executed perform steps, comprising:
receiving a request via a software program running on a computer system, the request corresponding to an audio and/or visual mode; and
controlling a switching mechanism from the computer system to match the audio and/or visual mode, including controlling the switching mechanism to couple one or more audio and/or visual outputs of a first device set, comprising at least one audio and/or visual device, to one or more audio and/or visual inputs of a second device set, comprising at least one other audio and/or visual device.

2. The computer-readable medium of claim 1 having further computer-executable instructions comprising, emitting signals to change a setting of at least one audio and/or visual device.

3. The computer-readable medium of claim 1 wherein the one or more audio and/or visual inputs correspond to at least one of a DVI input, an HDMI input, a composite video input, an S-video input, RF input, component video input, analog audio input, and digital audio input.

4. The computer-readable medium of claim 1 wherein the one or more audio and/or visual outputs correspond to at least one of a DVI output, an HDMI output, a composite video output, an S-video output, RF output, component video output, analog audio output, and digital audio output.

5. The computer-readable medium of claim 1 having further computer-executable instructions comprising, processing at least some audio and/or visual signals output from the first device set into processed signals, and outputting the processed signals to the one or more inputs of the second device set.

6. A system comprising,
a first device set comprising at least one audio and/or visual device having signal output capabilities;
a second device set comprising at least one audio and/or visual device having signal input capabilities;
a switching mechanism controlled by a computing device to couple output of the first device set to input of the second device set; and
the computing device receiving data corresponding to a selected mode and controlling the switch based on the selected mode.

7. The system of claim 6 wherein the switching mechanism is incorporated within or closely associated with the computing device.

8. The system of claim 6 wherein the switching mechanism is external to and remote from the computing device.

9. The system of claim 8 wherein the switching mechanism incorporated within or closely associated with the second device set.

10. The system of claim 6 wherein the first device set comprises at least one of the computing device, a media content player, a game console, and a set top box.

11. The system of claim 6 wherein the second device set comprises at least one of a television/monitor, an amplifier, and an audio receiver.

12. The system of claim 6 wherein the switching mechanism captures at least some of the signals output by the first device set for processing.

13. The system of claim 12 wherein the signals that are captured are processed by the computing device, including providing data corresponding to the captured signals for generating output via a frame buffer of a graphics subsystem.

14. The system of claim 6 wherein the switching mechanism is controllable to selectively capture a set of signals output by the first device or to switch the set of signals without capturing.

15. The system of claim 6 wherein the first device outputs one or more types of signals, including DVI signals, HDMI signals, composite video signals, S-video signals, RF signals, component video signals, analog audio signals, and digital audio signals, and wherein the second device inputs one or more types of signals, including DVI signals, HDMI signals, composite video signals, S-video signals, RF signals, component video signals, analog audio signals, and digital audio signals.

16. In an environment having at least one computer system, a first audio and/or visual source, a second audio and/or visual source and an audio and/or visual receiver, a method comprising:
controlling, via the computer system, a switch mechanism to couple the first audio and/or visual source to the audio and/or visual receiver;
receiving an audio and/or visual operating mode request at the computer system; and
controlling the switch mechanism via the computer system to couple the second audio and/or visual source to the audio and/or visual receiver to satisfy the request.

17. The method of claim 16 further comprising, receiving feedback at the computer system, the feedback corresponding to the controlling of the switch mechanism.

18. The method of claim 16 wherein controlling the switch mechanism to satisfy the request includes evaluating at least one input and output based on digital rights management/content protection to determine whether and how to satisfy the request.
